(19) United States
(12) Patent Application Publication
(10) Pub. No.: US 2002/0079127 A1
(43) Pub. Date: Jun. 27, 2002

(54) Coil for erecting cable and method for manufacturing said coil

(76) Inventors: Naohisa Miyakawa, Shiroi-cho (JP); Katsuhisa Kato, Moriya-machi (JP)

Correspondence Address: WENDEROTH, LIND & PONACK, L.L.P., 2033 K STREET N. W., SUITE 800, WASHINGTON, DC, 20006-1021, US

(21) Appl. No.: 10/024,561

(22) Filed: Dec. 21, 2001

(30) Foreign Application Priority Data
Dec. 25, 2000 (JP) 2000-404628

(51) Int. Cl. H01B 7/00

(52) U.S. Cl. 174/110 R

(57) ABSTRACT

A coil for erecting cable comprises a coil body (1) formed of a metal wire (2) and of a coated layer (3) of synthetic resin mixed with inorganic powder disposed on the outer circumference of said metal wire (2), wherein said coil body (1) is provided at the outer circumference with spiral torsion portion (6) formed by applying torsion along the longitudinal direction to the cable body (1). A method for manufacturing the coil for erecting cable comprises steps of supplying the metal wire (2) to a mold die (11), extruding synthetic resin mixed with inorganic powder by a first extrusion molding machine (10) on the outer circumference of the metal wire (2) in said mold die (11) to form the coated layer (3) on the metal wire (2), supplying the coil body (1) having the coated layer (3) from the mold die (11) to a sizing die (12), and forming the spiral torsion portion (6) formed by applying torsion along the longitudinal direction to the coil body (1) on the outer circumference of the coil body (1) in the sizing die (12).

### BACKGROUND OF THE INVENTION

1. Field of the Invention

The present invention relates to a coil for erecting cable, particularly a coil to be used to erect various kinds of cables such as communication cable, electric power cable, etc. and a method for manufacturing said coil.

2. Description of the Prior Art

In the method of the prior art of erecting all kinds of cables, such as communication cable and electric power cable, a messenger wire is installed firstly between poles, cable hangers are then fitted on the messenger wire, and cable is erected on the cable hangers. However, the erection of cable by means of the cable hanger is involved in such troublesome problems that the operator has to carry a number of cable hangers and fit the number of cable hangers on the messenger wire at the regular intervals. In order to solve such problems, a coil for erecting cable with spiral shape and elasticity has been proposed. However, this coil for erecting cable is apt to get its original spiral condition regained easily even though the coil is installed in a fully pulled condition, so that the erection of cable by the means of this coil is also caused troublesome problems of taking many times in erecting cable, causing noise of wind upon lashing against said coil, attaching many rain-drops to said coil, and freezing-up of rain-drops in the winter seasons which increases the weight of coil thereby hanging it down.

### SUMMARY OF THE INVENTION

An object of the present invention is to solve the problems of the conventional art mentioned above and is to provide a coil for erecting cables which enable to erect simply and reliably all kinds of cables, such as communication cable and electric power cable.

Another object of the present invention is to provide a coil for erecting cable which can reduce the noise of wind which may arise on the coil kept installed.

Another object of the present invention is to provide a coil for erecting cable which is provided with water repellency and less frictional resistance and which is durable for long term.

Another object of the present invention is to provide a method for manufacturing said coil for erecting cable which can simply and easily be manufactured in a continuous process.

A coil for erecting cable in accordance with the present invention comprises a coil body formed of a metal wire and of a coated layer of synthetic resin mixed with inorganic powders disposed on the outer circumference of said metal wire, and said coil body is provided at the outer circumference with spiral torsion portion formed by giving torsion along the longitudinal direction to the coil body. The coil body includes a protective film layer of water repellency laminated on the coated layer of the outer circumference of the coil body. The protective film layer may be provided with a rough surface having irregularities formed in an outer surface.

A method for manufacturing the coil for erecting cable according to the present invention comprises steps of supplying a metal wire into a mold die, extruding synthetic resin mixed with inorganic powder by a first extrusion molding machine to the outer circumference of the metal wire in the mold die to form a coated layer, supplying a coil body having the coated layer extruded on the metal wire from the mold die into a sizing die, and forming a spiral torsion portion on the outer circumference of the coil body by applying torsion along the longitudinal direction of the coil body in the sizing die. Further, the coil body can be formed in such way that a protective film layer having a flat outer surface or a protective film layer having a rough outer surface with irregularities is extruded by a second extrusion molding machine in the mold die on the coated layer extruded by the first extrusion molding machine onto the outer circumference of the metal wire.

### BRIEF DESCRIPTION OF THE DRAWINGS

FIG. 1 is a perspective view of a coil body having a coated layer laminated on the outer circumference of a metal wire according to the present invention.

FIG. 2 is a sectional view taken along the line A-A of FIG. 1.

FIG. 3 is a sectional view of a coil body having a coated layer and a protective film layer laminated on the outer circumference of the metal wire according to the present invention.

FIG. 4 is a sectional view of a coil body provided with a rough surface on the outer circumference of the protective film layer.

FIG. 5 is a schematic diagram showing a process for manufacturing the coil body of the present invention by using one extrusion molding machine.

FIG. 6 is a schematic diagram showing a process for manufacturing the coil body of the present invention by using two extrusion molding machines.

FIG. 7 is a schematic diagram showing a process for manufacturing the coil body having a pre-cooling bath arranged before a sizing die.

FIG. 8 is an illustration view showing a mounted conditions wherein a communication cable is erected by a coil body according to the present invention.

### DETAILED DESCRIPTION OF THE PREFERRED EMBODIMENT

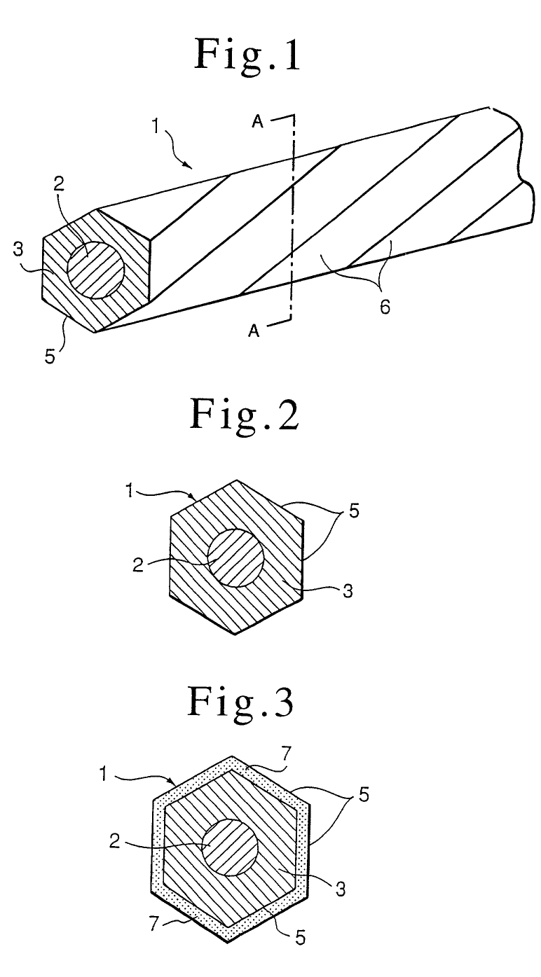

A coil for erecting cable shown in FIG. 1 comprises a coil body 1 which has a longitudinal metal wire 2 and a coated layer 3 in the shape of the hexagon 5 in cross section formed by synthetic resin mixed with inorganic powder on the outer circumference of the metal wire 2. In addition, the coil body 1 having a coated layer 3 laminated on the metal wire 2 is provided at the outer circumference with a spiral torsion portion 6 formed by revolving the coil body 1 and applying torsion to the coil body 1 at the condition running in the longitudinal direction.

The coil body 1 shown in FIG. 3 includes a protective film layer 7 which is formed by having synthetic resin with water repellent laminated on the outer circumference of the coated layer 3. The coil body 1 having the coated layer 3 and the protective film layer 7 is provided at the outer circumference with the spiral torsion portion 6 formed by turning the coil body and applying torsion to the coil body 1 running in the longitudinal direction as mentioned in the embodiment shown in FIG. 1 and 2.

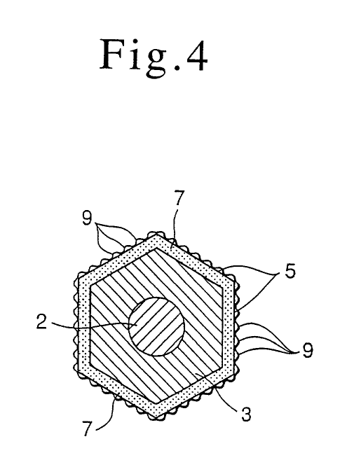

The coil body 1 shown in FIG. 4 includes a protective film layer 7 having a rough surface 9 with irregularities formed on the outer surface thereof. Said rough surface 9 with irregularities can be formed by extruding mixture of synthetic resins composed of a base material of synthetic resin having low melt viscosity and high fluidity and additives of powder or particle of synthetic resin having high melt viscosity and low fluidity.

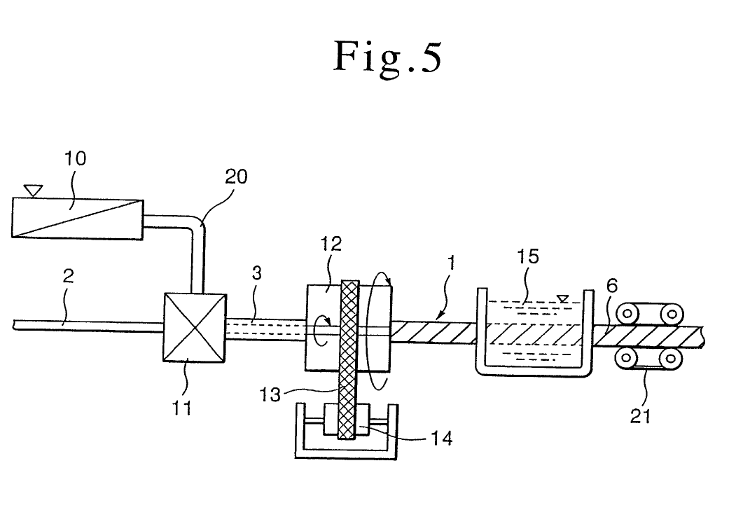

In the embodiment of the manufacturing method shown in FIG. 5 the metal wire 2 is supplied into a mold die 11 which is connected through a feeding pipe 20 to a first extrusion molding machine 10 into which synthetic resin mixed with inorganic powder to form the coated layer 3 is poured. When the metal wire 2 is inserted into said mold die 11, the synthetic resin mixed with inorganic powder of the coated layer 3 is supplied to the mold die 11 by actuating the first extrusion molding machine 10 to laminate the coated layer 3 onto the outer circumference of the metal wire 3 in the mold die 11.

Subsequently, the coil body 1 having the coated layer 3 laminated on the outer circumference of the metal wire 2 is forwarded into a sizing die 12, in which the spiral torsion portion 6 is formed by revolving the sizing die 12 in the outer surface of the coil body 1. Said sizing die 12 is connected through a rotating belt 13 to a motor 14 and is rotated by the motor 14. The coated layer 3 of the coil body 1 is continuously subjected to spiral torsion due to the rotation of the sizing die 12, and then the coil body 1 with spiral torsion portion 6 is forwarded through a cooling water bath 15 and a pulling unit 21 and is wound by means of winding drum.

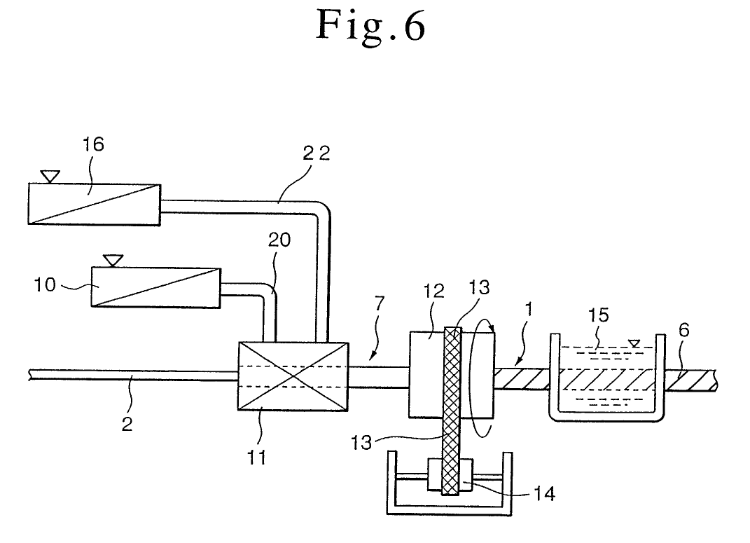

In the embodiment of the manufacturing method shown in FIG. 6, the metal wire 2 is supplied to the mold die 11 which is connected through the feeding pipe 20 to the first extrusion molding machine 10 and is connected through a feeding pipe 22 to a second extrusion molding machine 16. The first extrusion molding machine 10 is filled with the synthetic resin mixed with inorganic powder for forming the coated layer 3 and second extrusion molding machine 16 is filled with synthetic resin for forming a protective film layer 7 with flat outer surface of water repellency or mixture of synthetic resins for forming the protective film layer 7 having a rough surface with irregularities on the outer surface. When the metal wire 2 is introduced into the mold die 11, the synthetic resin of the coated layer 3 is poured by actuating the first extrusion molding machine 10 into the mold die 11 from the feeding pipe 20, whereby said coated layer 3 is extruded and formed on the outer circumference of said metal wire 2. Subsequently the synthetic resin or mixed synthetic resin of the protective film layer 7 is poured by actuating the second extrusion molding machine 16 into the mold die 11 through the feeding pipe 22, whereby the protective film layer 7 of water repellent, or the protective film layer 7 having the rough surface 9 with irregularities on the outer surface is extruded on the outer circumference of said coated layer 3 and is integrally molded with the coated layer 3 within the mold die 11. Further, the coil body 1 having the coated layer 3 and protective film layer 7 laminated on the outer circumference of the metal wire 2 is introduced into a sizing die 12 and spiral torsion portion 6 is formed by turning the sizing die 12 on the outer surface of the coil body 1 with the sizing die 12. Subsequently, the coil body 1 having the spiral torsion portion 6 on the outer surface is passed through the cooling liquid bath 15 and is wound by winding drum via the pulling unit 21.

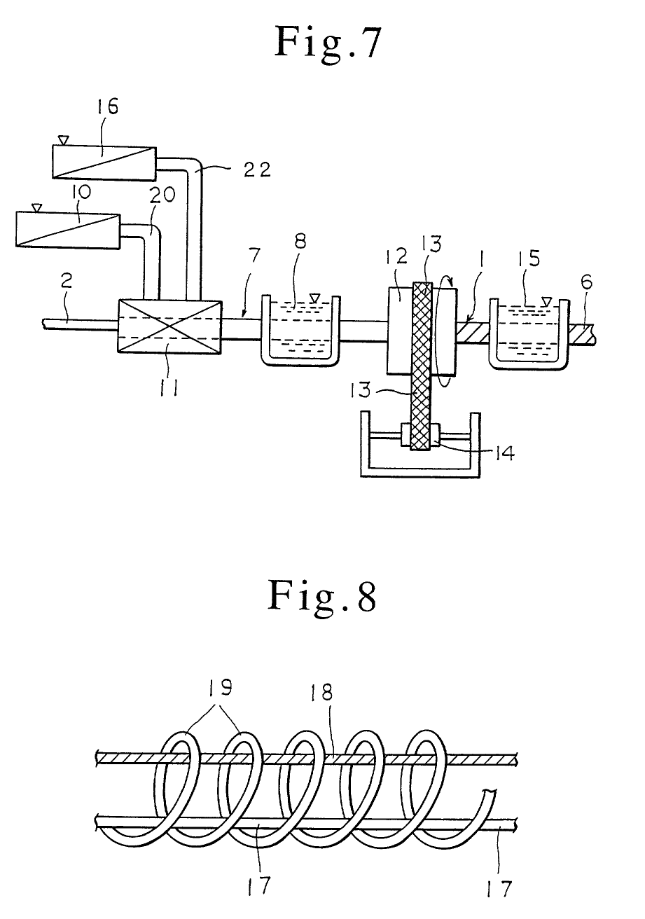

In the embodiment of the manufacturing method shown in FIG. 7, a pre-cooling liquid bath 8 is disposed prior to said sizing die 12 in order to prevent the sizing die 12 from getting heated, because the temperature of the coil body 1 passing through the mold die 11 is high. Therefore, the coil body 1 is cooled first in said pre-cooling liquid bath 8 and then is cooled again in the cooling liquid bath 15 after it has passed through said sizing die 12 eventually to cool the coil body 1 down completely.

The metal wire 2 of the coil body 1 uses iron wire, copper wire, stainless steel wire, aluminum wire, etc. and the component of the coated layer 3 on the outer circumference of said metal wire 2 uses synthetic resin based on polyolefin, polystyrene, polyester, etc., to which inorganic powder is mixed. As the inorganic powder, talc, magnesium hydroxide, aluminum hydroxide, etc. are used. The mixing ratio of said synthetic resin to the inorganic powder is within a range of 15 weight % to 80 weight %, preferably 30 weight % to 65 weight %. As one example of the present invention, when the coated layer 3 comprising synthetic resin of olefin based polypropylene resin mixed with talc in 40 weight % is used on the outer circumference of iron wire selected as metal wire 2, the coil for erecting cable of the present invention has demonstrated that the reaction force for restoration is smaller even when the spiral coil body is pulled out. If the fire retardance is required for the coated layer 3, magnesium hydroxide or aluminum hydroxide which is superior in fire retardance can also be used as the inorganic powder. It is preferred to make the cross sectional of the coated layer 3 in the shape of polygon or non-circular form. In the case that said coated layer 3 is required to have water repellency on the outer surface, olefin based resin, silicon based resin, fluorine based resin, polystylene based resin, polyester based resin, etc. can be used and a fire retardant may also be added to such resin.

The mixed synthetic resin of the protective film layer 7 having the rough surface with irregularities on the outer surface uses low viscosity polyethylene of more less than 0.5 g/10 minute of melt flow rate (ASTM D1238 190° C.) as synthetic resin of the base material having low melt viscosity and high fluidity, and uses high viscosity polyethylene of less than 0.1 g/10 minute of melt flow rate (ASTM D1238 190° C.) as powder or particles of synthetic resin of the additives having high meet viscosity and low fluidity. When the mixed synthetic resin, of which powder or particles of high viscosity polyethylene is mixed to low viscosity polyethylene is extruded to form the protective film layer 7, the powder or particles of high viscosity polyethylene is not fluidized to remain the shape to some extent to form the rough surface 9 even in the case of the extrusion molding at the high temperature over melting point. The coil body 1 of the present invention can be provided with water repellency and can make the frictional resistance smaller by mean of this rough surface with irregularities.

According to the manufacturing method of the present invention, the mixed synthetic resin with inorganic powder or particles in melting condition to form the coated layer 3 is laminated by means of the first extrusion molding machine 10 on the outer circumference of the metal wire 2 passing through the inside of the mold die 11, and then the coil body 1 is introduced through the mold die 11 into the revolving sizing die 12, wherein the spiral torsion portion 6 is formed by applying the revolution of the longitudinal direction to the sizing die 12 on the coil body 1. The sizing die 12 can be rotated in either direction in the clockwise direction or the counter clockwise direction.

The mold die 11 is heated to the same temperature with the molding temperature of the first extrusion molding machine 10, but the temperature of the revolving sizing die 12 is room temperature or is kept in an air cooled condition. The polygon shape of the coil body 1 can be formed by either die of the sizing die 12 or the mold die 11, but it is preferred to mold the polygon shape of the coil body 1 with the mold die 11 and to mold the torsion portion 6 with the sizing die 12.

According to the manufacturing method of the present invention to have the protective film layer 7 of water repellency and low frictional resistance laminated on the outer circumference of the coated layer 3, the synthetic resin of the coated layer 3 in the melting condition is laminated by the first extrusion molding machine 10 on the outer circumference of the metal wire 2 passing inside of the mold die 11 and the mixed synthetic resin in melting condition to form the protective film layer 7 having the rough surface 9 is laminated by the second extrusion molding machine 16 on the outer circumference of the coated layer 3 laminated on the metal wire 2 in the mold die 11. The coil body 1 is then introduced through the mold die 11 into the sizing die 12, wherein the spiral torsion portion 6 is formed by the longitudinal revolution of the sizing die 12 on the outer surface of the coil body 1 having the coated layer 3 and the protective film layer 7 laminated.

FIG. 8 illustrates the condition having a communication cable 17 erected by a coil 19 for erecting cable according to the present invention, wherein the communication cable 17 can be erected by winding spirally the coil 19 in parallel to a messenger wire 18 installed between the poles.

The coil for erecting cable according to the present invention can be handled easily in the erection of the various cable and the fixing operation is extremely easier and more reliable in comparison with those using the conventional cable hangers, as the spiral coil body of this invention is not restored to the original spiral coil condition, because of the weak restoring force of the coated layer, when the cable is erected by the spiral coil body along the message wire. Moreover, the coil body according to the present invention is tough at the outer circumstance, it may be prevented to adhere water-drop on the outer circumstance of the coil body due to exhaling the raining and snowing moisture, and the noise of wind can be reduced, because of low friction resistance of the outer surface of the coil body.

What is claimed is:

1) A coil for erecting cable comprising a coil body formed of a metal wire and of a coated layer of synthetic resin mixed with inorganic powder disposed on the outer circumference of said metal wire, wherein said coil body is provided at the outer circumference with a spiral torsion portion formed by applying torsion along the longitudinal direction to the coil body.

2) A coil for erecting cable as claimed in claim 1, wherein said coated layer is laminated with a protective film layer of synthetic resin with water repellent.

3) A coil for erecting cable wherein said protective film layer is provided with a rough surface having many irregularities formed by extruding a mixture of base material of synthetic resin having low melting viscosity and high fluidity and additives of powder and particles of synthetic resin having high melting viscosity and low fluidity.

4) A method for manufacturing a coil for erecting cable comprising steps of supplying a metal wire to mold die, extruding synthetic resin mixed with inorganic powder by a first extrusion molding machine on the outer circumference of said metal wire in said mold die to form a coated layer on the outer circumference of said metal wire, introducing the coil body having the coated layer from the metal mold die into a sizing die, and forming spiral torsion portion by applying torsion along the longitudinal direction to the coil body on the outer circumference of the coil body in said sizing die.

5) A method for manufacturing a coil for erecting cable comprising steps of supplying a metal wire into a mold die, extruding synthetic resin mixed with inorganic powder by a first extrusion molding machine on the outer circumstance of said metal cable in the mold die to form a coated layer on the circumstance of the metal cable, extruding synthetic resin having water repellency to form a protective film layer with a flat outer surface or a mixture of synthetic resins of base material and additives to form a protective film layer having a rough surface with irregularities on the outer surface by a second extrusion molding machine on the outer circumference of the metal wire, forming integrally the protective film layer of water repellent having the flat outer surface on the outer circumference of the coated layer or the protective film layer having the rough surface portion with irregularities on the outer circumference of the coated layer, introducing the coil body having the coated layer and protective film layer from the mold die into the sizing die, and forming spiral torsion portion on the outer circumference of the coil body by applying torsion along the longitudinal direction to the coil body in the sizing die.
